(19) United States
(12) Patent Application Publication
(10) Pub. No.: US 2017/0330244 A1
(43) Pub. Date: Nov. 16, 2017

(54) METHOD AND APPARATUS FOR REQUESTING AN OPPORTUNITY TO ADVERTISE ONLINE

(71) Applicant: TEGME s.r.l., Rome (IT)

(72) Inventor: Andrea IONTA, Terracina (LT) (IT)

(21) Appl. No.: 15/588,949

(22) Filed: May 8, 2017

Related U.S. Application Data
(60) Provisional application No. 62/334,135, filed on May 10, 2016.

(51) Int. Cl. G06Q 30/02

(52) U.S. Cl. CPC G06Q 30/0275; G06Q 30/0277

(57) ABSTRACT

A method and apparatus may include displaying an online content to a user. The method may also include displaying a graphical control associated with the online content. The graphical control is configured to receive a request to advertise in association with the online content. The graphical control is only displayed when there is an opportunity to advertise in association with the online content. The online content and the graphical control are displayed together. The method may also include determining that the user has accessed the graphical control. The method may also include displaying at least one option for purchasing an opportunity to advertise in association with the online content. The method may also include receiving payment from the user to purchase the opportunity to advertise in association with the online content. The method may also include granting the opportunity to advertise in association with the online content.

### CROSS REFERENCE TO RELATED APPLICATIONS

This application claims priority under 35 USC §119(e) from U.S. Provisional Patent Application No. 62/334,135, filed on May 10, 2016, the contents of which is hereby incorporated by reference.

### BACKGROUND

### Field

Certain embodiments of the present invention relate to requesting an opportunity to advertise online.

### Description of the Related Art

Online advertising is a form of advertising that uses the Internet to deliver promotional messaging to customers. An advertiser may provide the online advertisements to a publisher, and the publisher may incorporate the online advertising alongside or within online content. Online advertising may convey promotional messaging via text, logos, photographs, pictorials, or videos, for example.

### SUMMARY

According to a first embodiment, a method may include displaying an online content to a user. The method may also include displaying a graphical control associated with the online content. The graphical control is configured to receive a request to advertise in association with the online content. The graphical control is only displayed when there is an opportunity to advertise in association with the online content. The online content and the graphical control are displayed together at the same time. The method may also include determining that the user has accessed the graphical control. The method may also include displaying at least one option for purchasing an opportunity to advertise in association with the online content. The method may also include receiving payment from the user to purchase the opportunity to advertise in association with the online content. The method may also include granting the opportunity to advertise in association with the online content.

In the method of the first embodiment, the graphical control comprises a clickable icon.

In the method of the first embodiment, the online content comprises an online article, an online pictorial, and/or an online video.

In the method of the first embodiment, the displaying at least one option for purchasing an opportunity to advertise comprises displaying at least one of a fast-buy option, a bid option, and an auction option.

According to a second embodiment, an apparatus may include at least one processor. The apparatus may also include at least one memory comprising computer program code. The at least one memory and the computer program code are configured, with the at least one processor, to cause the apparatus at least to display an online content to a user. The apparatus may also be caused to display a graphical control associated with the online content. The graphical control is configured to receive a request to advertise in association with the online content, the graphical control is only displayed when there is an opportunity to advertise in association with the online content, and the online content and the graphical control are displayed together at the same time. The apparatus may also be caused to determine that the user has accessed the graphical control. The apparatus may also be caused to display at least one option for purchasing an opportunity to advertise in association with the online content. The apparatus may also be caused to receive payment from the user to purchase the opportunity to advertise in association with the online content. The apparatus may also be caused to grant the opportunity to advertise in association with the online content.

In the apparatus of the second embodiment, the graphical control comprises a clickable icon.

In the apparatus of the second embodiment, the online content comprises an online article, an online pictorial, and/or an online video.

In the apparatus of the second embodiment, the displaying at least one option for purchasing an opportunity to advertise comprises displaying at least one of a fast-buy option, a bid option, and an auction option.

According to a third embodiment, a computer program product may be embodied on a non-transitory computer readable medium. The computer program product may be configured to control a processor to perform a method. The method may include displaying an online content to a user. The method may also include displaying a graphical control associated with the online content. The graphical control is configured to receive a request to advertise in association with the online content, the graphical control is only displayed when there is an opportunity to advertise in association with the online content, and the online content and the graphical control are displayed together at the same time. The method may also include determining that the user has accessed the graphical control. The method may also include displaying at least one option for purchasing an opportunity to advertise in association with the online content. The method may also include receiving payment from the user to purchase the opportunity to advertise in association with the online content. The method may also include granting the opportunity to advertise in association with the online content.

In the computer program product of the third embodiment, the graphical control comprises a clickable icon.

In the computer program product of the third embodiment, the online content comprises an online article, an online pictorial, and/or an online video.

In the computer program product of the third embodiment, the displaying at least one option for purchasing an opportunity to advertise comprises displaying at least one of a fast-buy option, a bid option, and an auction option.

### BRIEF DESCRIPTION OF THE DRAWINGS

For proper understanding of the invention, reference should be made to the accompanying drawings, wherein:

FIG. 1 illustrates a screen shot of an example interface for a content producer/publisher to edit an offered opportunity to advertise, in accordance with certain embodiments of the present invention.

FIG. 2 illustrates a screen shot of another example interface for a content producer/publisher to view different requests to advertise, received from advertisers, in accordance with certain embodiments of the present invention.

FIG. 3 illustrates a screen shot of another example interface for a content producer/publisher to view different requests to advertise, received from advertisers, in accordance with certain embodiments of the present invention.

FIG. 4(a) illustrates a first part of a system for purchasing/bidding for opportunities to advertise, in accordance with certain embodiments of the present invention.

FIG. 4(b) illustrates a second part of the system for purchasing/bidding for opportunities to advertise, in accordance with certain embodiments of the present invention.

FIG. 5(a) illustrates an example screenshot for purchasing/bidding for an opportunity to advertise, in accordance with certain embodiments of the present invention.

FIG. 5(b) illustrates an example screenshot of an interface that may be used by an advertiser, in accordance with certain embodiments of the present invention.

FIG. 5(c) illustrates an example screenshot of another interface that may be used by an advertiser, in accordance with certain embodiments of the present invention.

FIG. 5(d) illustrates an example screenshot of another interface that may be used by an advertiser, in accordance with certain embodiments of the present invention.

FIG. 5(e) illustrates an example screenshot of another interface that may be used by an advertiser, in accordance with certain embodiments of the present invention.

FIG. 5(f) illustrates an example screenshot of another interface that may be used by an advertiser, in accordance with certain embodiments of the present invention.

FIG. 5(g) illustrates an example screenshot of another interface that may be used by an advertiser, in accordance with certain embodiments of the present invention.

FIG. 6 illustrates a flowchart of a method in accordance with certain embodiments of the invention.

FIG. 7 illustrates an apparatus in accordance with certain embodiments of the invention.

FIG. 8 illustrates an apparatus in accordance with certain embodiments of the invention.

### DETAILED DESCRIPTION

Certain embodiments of the present invention relate to requesting an opportunity to advertise online. Specifically, certain embodiments of the present invention may directly connect potential advertisers to content producers and publishers. With certain embodiments, advertisers can readily ascertain opportunities for placement of the advertisers' advertisements, and the advertisers may then engage the content producers/publishers to provide payment for the opportunity to advertise, as described in more detail below. Certain embodiments may allow an advertiser to place their advertisements in association with specific content, where the advertiser can communicate a desire to place advertisements in association with the specific content by clicking on a portion and/or an icon of the specific content. The desire is communicated to the content creator/producer.

With the previous approaches of online advertising, if an advertiser is interested in placing advertisements in association with specific content, the advertiser would typically need to determine how to contact the content producer, the publisher of the content, or a third-party agent of the content producer. The advertiser may need to spend significant amounts of time in their effort to determine the proper contact information, because the proper point of contact may not be readily apparent to the advertiser. Further, because the advertiser may not know which method of contact is preferred by the proper point of contact, the advertiser may use an improper method of contact, thus further expending time and effort.

Further, with the previous approaches, even if the advertiser identifies content that the advertiser would like to place advertise on, the advertiser will generally not know whether or not the content producer is receptive to displaying further advertisements. Finally, with the previous approaches, the advertiser will generally not know the costs associated with placing advertising in association with the content.

From the perspective of the content producer/publisher, with the previous approaches, the producer/publisher may not be able to ascertain the monetary value of potential advertisements for their created content.

In contrast with the previous approaches, certain embodiments of the present invention allow an advertiser to readily ascertain that a content producer/publisher is receptive to displaying additional advertisements. Certain embodiments allow an advertiser to readily know the price of displaying advertisements as well. Certain embodiments also allow the advertiser to easily initiate contact with the content producer/publisher. Further, in contrast with the previous approaches, certain embodiments of the present invention allow the content producer/publisher to determine the demand and monetary value of potential advertisements.

Therefore, a person of skilled in the art would understand that embodiments of the present invention provide significant improvements to various technologies associated with online advertising utilizing a computer network, and proper placement of proper content, as well as appropriate determinations of demand and monetary value of advertising.

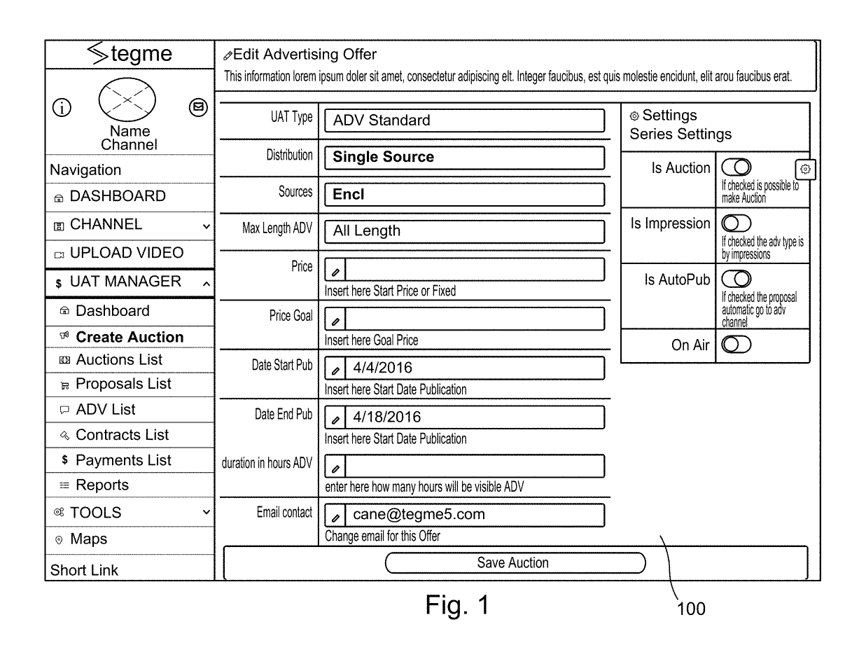

Certain embodiments of the present invention allow a content producer/publisher to determine parameters that are to be met by the advertisers who wish to place advertisements in association with the content. FIG. 1 illustrates a screen shot of an example interface for a content producer/publisher to edit an offered opportunity to advertise, in accordance with certain embodiments of the present invention. Interface 100 includes a “UAT Type” (i.e., “User Advertising Tool Type”) parameter that may determine how the opportunity to advertise will be priced. For example, one option of the “UAT Type” parameter is “Fast Buy,” where the content producer/publisher provides a specific price that the advertiser must be willing to pay in order to have the opportunity to display advertisements in association with the specified content. Another option of the “UAT Type” may be “Bid,” where the content producer/publisher is accepting bids from different advertisers for the opportunity to advertise. Another option of the “UAT Type” parameter may be “Auction,” where different bidders may submit bids of increasingly larger amounts for a predetermined amount of time, and where the highest bidder may win the opportunity to advertise. With certain embodiments, with these “UAT Type” options, a content producer/publisher can discover the potential monetary benefits of allowing advertising to be placed in association with the content.

Interface 100 may also include a “Distribution” parameter that may determine how the advertisement is to be shown. For example, one option of the “Distribution” parameter may be “Single Source,” where the advertisement will be displayed with a single source of content, a single source. Alternatively, another option of the “Distribution” parameter may allow the advertisement to be displayed alongside a plurality of content sources. Interface 100 may also include a “Date Start Pub” parameter which determines the starting date for which the advertisement will be displayed. Interface 100 may also include a “Date End Pub” parameter which determines the ending date until which the advertisement will be displayed.

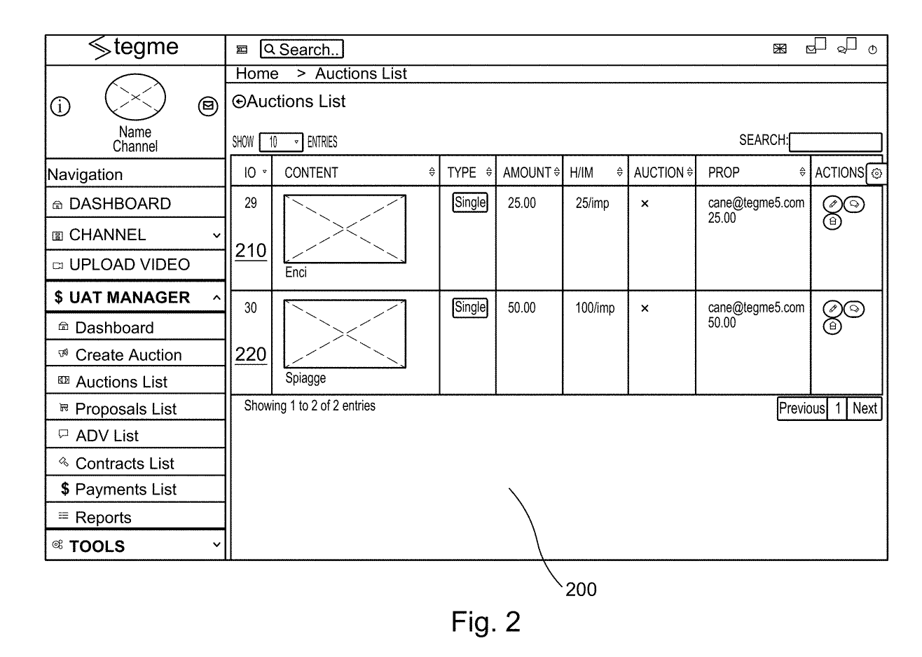

FIG. 2 illustrates a screen shot of another example interface for a content producer/publisher to view different requests to advertise, received from advertisers, in accordance with certain embodiments of the present invention. FIG. 2 may show the current, ongoing auctions for the opportunity to advertise on the content of the content producer/publisher. In the example of FIG. 2, auction 210 corresponds to an auction for the opportunity to advertise with content “End,” and auction 220 corresponds to an auction for the opportunity to advertise with content “Spiagge.”

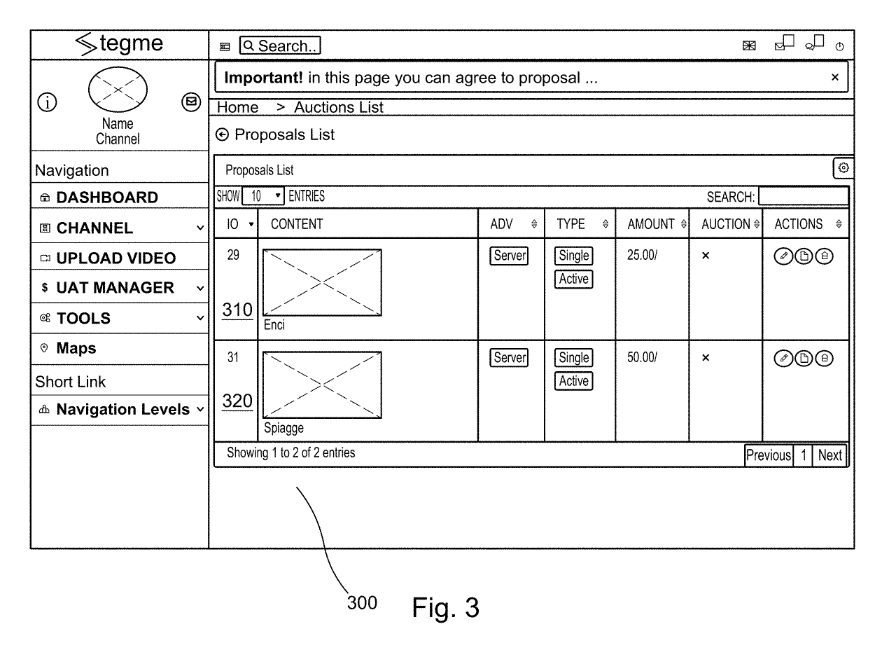

FIG. 3 illustrates a screen shot of another example interface for a content producer/publisher to view different requests to advertise, received from advertisers, in accordance with certain embodiments of the present invention. In the example illustrated by FIG. 3, a proposal 310 has been received from an advertiser to advertise on content “Encl.” Additionally, a proposal 320 has been received from an advertiser to advertise on content “Spiagge.” In the “Actions,” section, the content producer/publisher may remove, save, or respond to each of the received proposals.

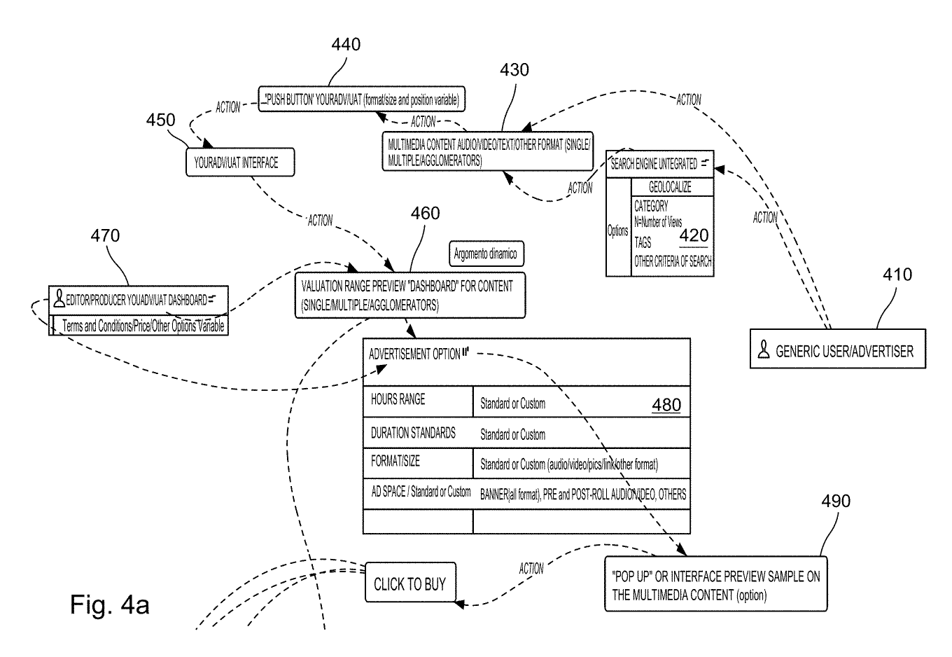

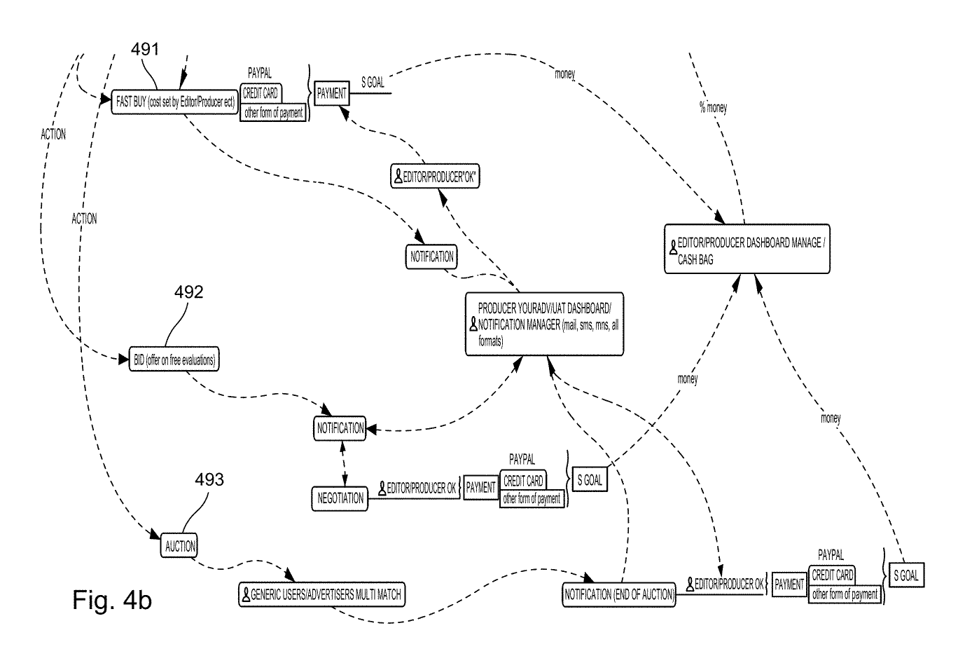

FIG. 4(a) illustrates a first part of a system for purchasing/bidding for opportunities to advertise, in accordance with certain embodiments of the present invention. Referring to FIG. 4(a), at 410, an advertiser can begin searching for content for which the advertiser would like to place advertisement in association with. At 420, with certain embodiments, the advertiser may search for content using an integrated search engine. For example, the advertiser may search for content that meets a certain “category,” that meets a certain number of views, that is associated with certain tags, and/or that meets any other types of criteria of search. At 430, the advertiser may have identified content that meets that advertiser's criteria. At 440, the advertiser may then provide an indication to the content publisher/producer that the advertiser wishes to advertise upon the content. For example, as discussed in further detail below, the advertiser may interact with a graphical control (such as, for example, an indicator or icon) that is associated with the content, in order to indicate the advertiser's desire to place advertisements in association with the content. At 450, the advertiser may then access an interface that is intended to be used by advertisers. On this interface, at 460, the advertiser can view different parameters of different advertising options that are associated with the selected content. The parameters may be determined based on terms and conditions that are set by the content publisher/producer at 470. The parameters may be determined by the advertiser using the interface shown in FIG. 1, for example. At 480, the advertiser can determine an “hours range,” which corresponds to an amount of hours that the advertisements should run. The advertiser may also determine a “format/size” of the advertisements. The advertiser may also determine whether the advertisements should be pre-rolls, post-rolls, audio advertisements, and/or video advertisements. At 490, with certain embodiments, the advertiser may preview how their advertisements will appear.

FIG. 4(b) illustrates a second part of the system for purchasing/bidding for opportunities to advertise, in accordance with certain embodiments of the present invention. After step 490, as shown in FIG. 4(a), the advertiser can purchase the advertising opportunity at the cost that is set by the content producer/publisher. Purchasing the advertising opportunity at this cost may be referred to as a “Fast Buy” 491, as shown by FIG. 4(b). Alternatively, the advertiser can submit a bid at 492. Alternatively, the advertiser can participate in an auction at 493.

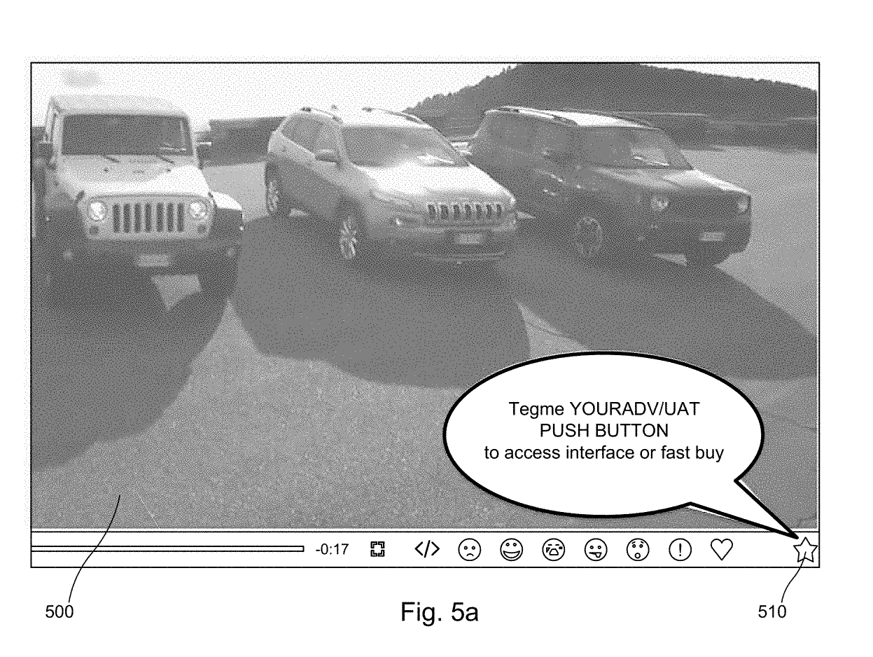

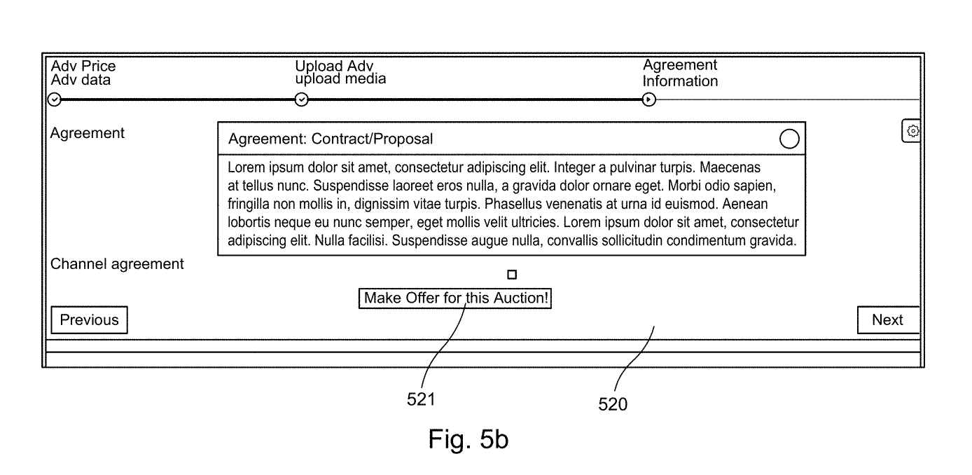

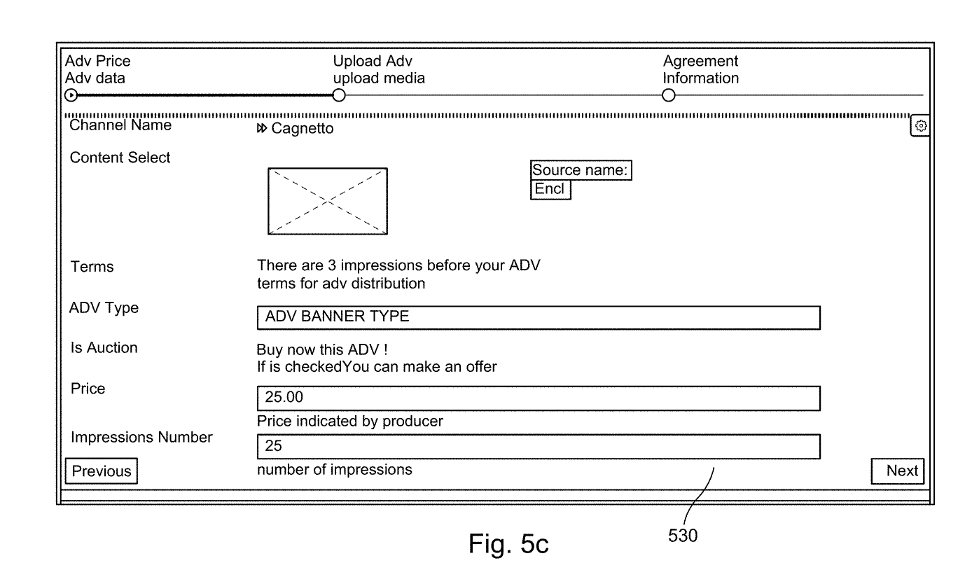

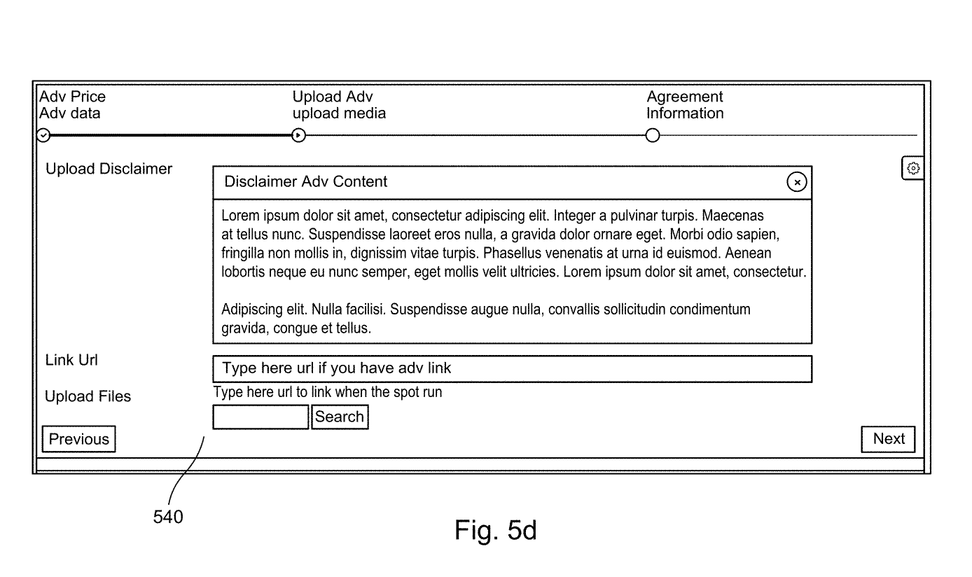

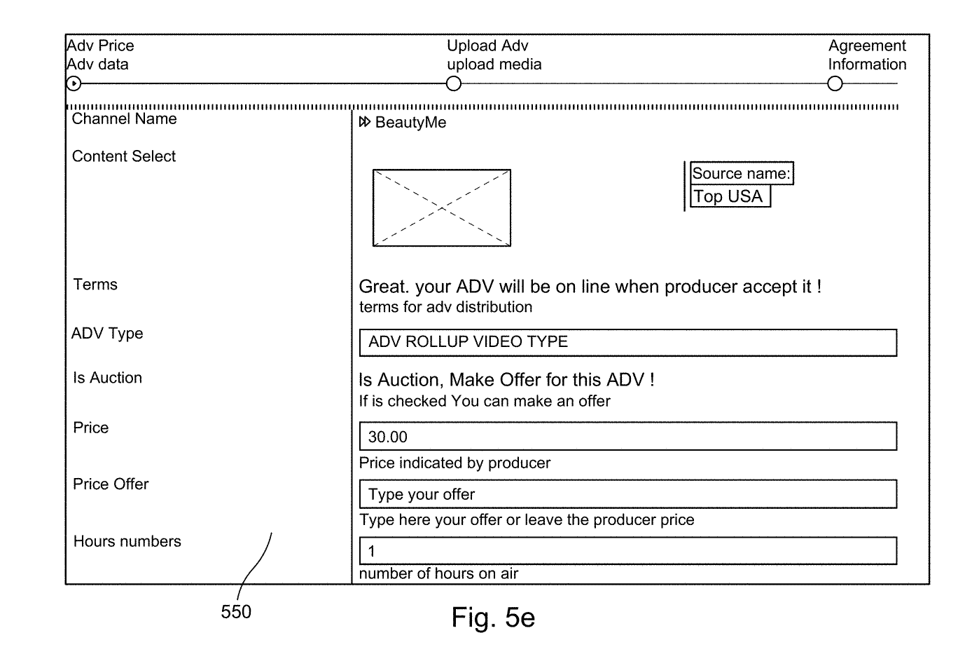

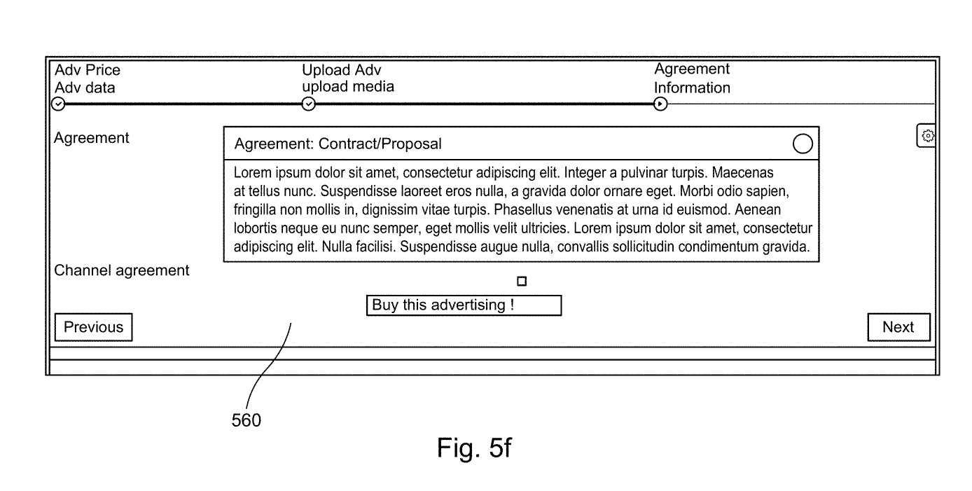

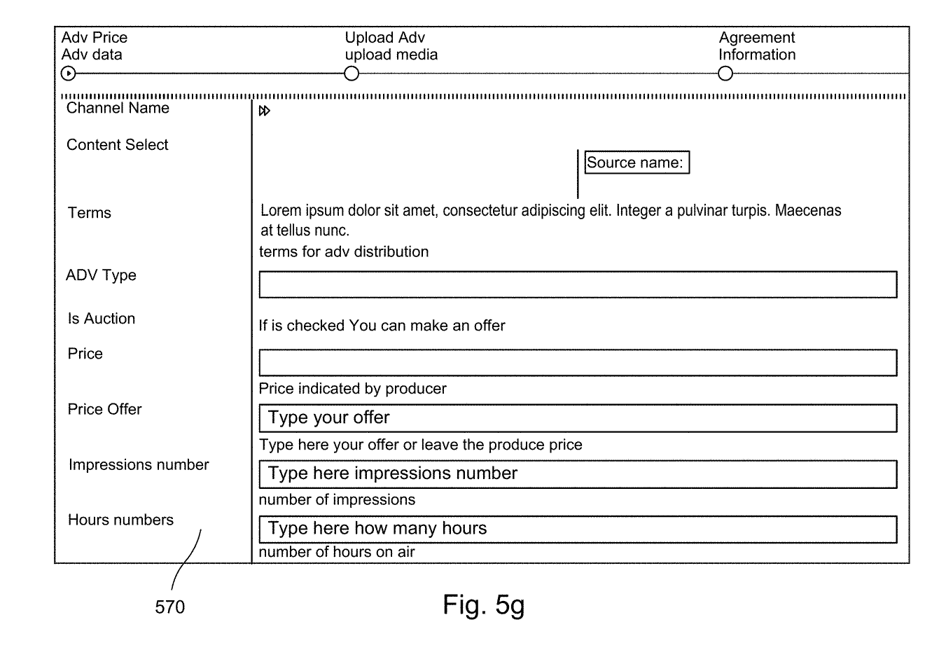

FIG. 5(a) illustrates an example screenshot for purchasing/bidding for an opportunity to advertise, in accordance with certain embodiments of the present invention. FIG. 5(a) illustrates an example online content 500 that corresponds to an example video. Example video content 500 is content that may be managed by a content producer/publisher. Online video content 500 can also include an associated graphical control 510 that indicates that online video content 500 is receptive to displaying advertisements. With certain embodiments, graphical control 510 may appear only if advertisements are permitted to be placed in association with content 500. Therefore, with certain embodiments, if an advertiser sees a graphical control 510, then the advertiser knows that the content publisher/producer is receptive to displaying advertising, and receptive to receiving requests to place advertisements. Further, the advertiser can interact with graphical control 510 to submit a request to advertise on content 500. By interacting with graphical control 510, the advertiser can then submit a proposal, submit a bid, participate in an auction, etc. In the event that the advertiser chooses to participate in an auction, the producer can view the active auction, as shown in FIG. 2. Graphical control 510 may be an icon that is clicked on by the advertiser, for example. Therefore, certain embodiments may allow an advertiser to submit a request to advertise with a single click on graphical control 510.

With certain embodiments, any advertiser can submit a request to advertise via graphical control 510. Therefore, certain embodiments may allow advertisers with limited budgets to try to participate in an advertising campaign, as compared to the previous approaches.

FIG. 5(b) illustrates an example screenshot of an interface 520 that may be used by an advertiser, in accordance with certain embodiments of the present invention. An advertiser can participate in an auction to purchase an opportunity to advertise via interface 520. For example, by clicking on button 521, an advertiser may make an offer for an auction.

FIG. 5(c) illustrates an example screenshot of another interface 530 that may be used by an advertiser, in accordance with certain embodiments of the present invention. An advertiser can purchase a certain number of impressions for a certain price, for example, via interface 530.

FIG. 5(d) illustrates an example screenshot of another interface 540 that may be used by an advertiser, in accordance with certain embodiments of the present invention. An advertiser can upload an advertisement to be displayed using interface 540.

FIG. 5(e) illustrates an example screenshot of another interface 550 that may be used by an advertiser, in accordance with certain embodiments of the present invention. An advertiser can type in an offer to participate in an auction.

FIG. 5(f) illustrates an example screenshot of another interface 560 that may be used by an advertiser, in accordance with certain embodiments of the present invention. The advertiser can click on a button to perform a “fast buy” to directly purchase the advertising opportunity.

FIG. 5(g) illustrates an example screenshot of another interface 570 that may be used by an advertiser, in accordance with certain embodiments of the present invention. The advertiser can submit an offer for a number of impressions, and a price for the impressions, for example.

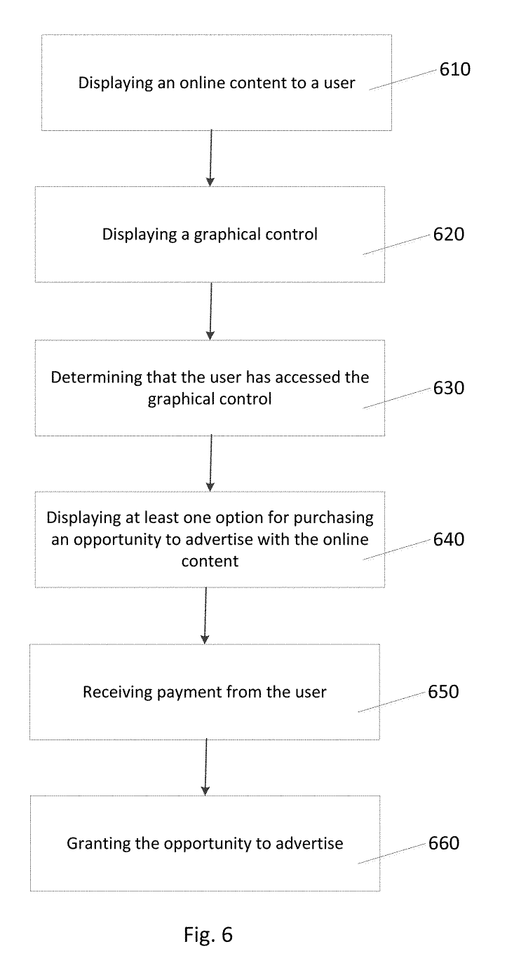

FIG. 6 illustrates a flowchart of a method in accordance with certain embodiments of the invention. The method illustrated in FIG. 6 includes, at 610, displaying an online content to a user. The method also includes, at 620, displaying a graphical control associated with the online content. The graphical control is configured to receive a request to advertise in association with the online content, the graphical control is only displayed when there is an opportunity to advertise in association with the online content, and the online content and the graphical control are displayed together at the same time. The method also includes, at 630, determining that the user has accessed the graphical control. The method also includes, at 640, displaying at least one option for purchasing an opportunity to advertise in association with the online content. The method also includes, at 650, receiving payment from the user to purchase the opportunity to advertise in association with the online content. The method also includes, at 660, granting the opportunity to advertise in association with the online content.

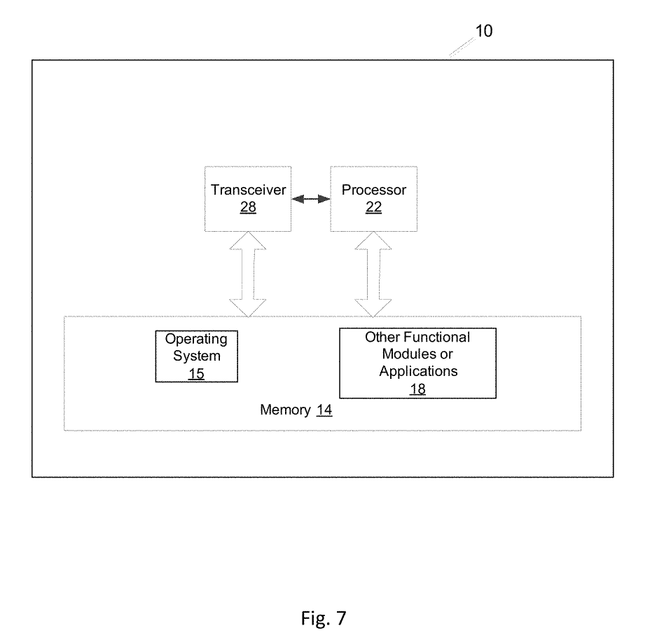

FIG. 7 illustrates an apparatus in accordance with certain embodiments of the invention. Apparatus 10 can include a processor 22 for processing information and executing instructions or operations. Processor 22 can be any type of general or specific purpose processor. While a single processor 22 is shown in FIG. 7, multiple processors can be utilized according to other embodiments. Processor 22 can also include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 can further include a memory 14, coupled to processor 22, for storing information and instructions that can be executed by processor 22. Memory 14 can be one or more memories and of any type suitable to the local application environment, and can be implemented using any suitable volatile or nonvolatile data storage technology such as a semiconductor-based memory device, a magnetic memory device and system, an optical memory device and system, fixed memory, and removable memory. For example, memory 14 include any combination of random access memory (RAM), read only memory (ROM), static storage such as a magnetic or optical disk, or any other type of non-transitory machine or computer readable media. The instructions stored in memory 14 can include program instructions or computer program code that, when executed by processor 22, enable the apparatus 10 to perform tasks as described herein.

Apparatus 10 can also include one or more antennas (not shown) for transmitting and receiving signals and/or data to and from apparatus 10. Apparatus 10 can further include a transceiver 28 that modulates information on to a carrier waveform for transmission by the antenna(s) and demodulates information received via the antenna(s) for further processing by other elements of apparatus 10. In other embodiments, transceiver 28 can be capable of transmitting and receiving signals or data directly.

Processor 22 can perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 can store software modules that provide functionality when executed by processor 22. The modules can include an operating system 15 that provides operating system functionality for apparatus 10. The memory can also store one or more functional modules 18, such as an application or program, to provide additional functionality for apparatus 10. The components of apparatus 10 can be implemented in hardware, or as any suitable combination of hardware and software. The above-described screenshots of interfaces can be generated by apparatus 10.

With certain embodiments, apparatus 10 can be configured to display an online content to a user. Apparatus 10 may also be configured to display a graphical control associated with the online content. The graphical control is configured to receive a request to advertise in association with the online content, the graphical control is only displayed when there is an opportunity to advertise in association with the online content, and the online content and the graphical control are displayed together at the same time. Apparatus 10 may also be configured to determine that the user has accessed the graphical control. Apparatus 10 may also be configured to display at least one option for purchasing an opportunity to advertise in association with the online content. Apparatus 10 may also be configured to receive payment from the user to purchase the opportunity to advertise in association with the online content. Apparatus 10 may also be configured to grant the opportunity to advertise in association with the online content.

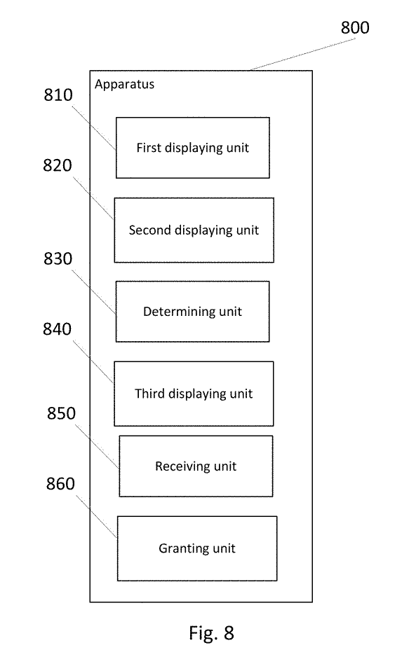

FIG. 8 illustrates an apparatus in accordance with certain embodiments of the invention. Apparatus 800 can include a first displaying unit 810 that displays an online content to a user. Apparatus 800 can also include a second displaying unit 820 that displays a graphical control associated with the online content. The graphical control is configured to receive a request to advertise in association with the online content. The graphical control is only displayed when there is an opportunity to advertise in association with the online content, and the online content and the graphical control are displayed together at the same time. Apparatus 800 can also include a determining unit 830 that determines that the user has accessed the graphical control. Apparatus 800 can also include a third displaying unit 840 that displays at least one option for purchasing an opportunity to advertise in association with the online content. Apparatus 800 can also include a receiving unit 850 that receives payment from the user to purchase the opportunity to advertise in association with the online content. Apparatus 800 can also include a granting unit 860 that grants the opportunity to advertise in association with the online content.

The described features, advantages, and characteristics of the invention can be combined in any suitable manner in one or more embodiments. One skilled in the relevant art will recognize that the invention can be practiced without one or more of the specific features or advantages of a particular embodiment. In other instances, additional features and advantages can be recognized in certain embodiments that may not be present in all embodiments of the invention. One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

1. A method, comprising:
displaying an online content to a user;
displaying a graphical control associated with the online content, said graphical control being configured to receive a request to advertise in association with the online content, the graphical control being displayed when there is an opportunity to advertise in association with the online content, wherein the online content and the graphical control are displayed simultaneously;
determining that the user has accessed the graphical control;
determining that the user has accessed the graphical control;
displaying at least one option for purchasing an opportunity to advertise in association with the online content;
receiving payment from the user to purchase the opportunity to advertise in association with the online content; and
granting the opportunity to advertise in association with the online content.

2. The method according to claim 1, wherein the displaying of the graphical control comprises displaying a clickable icon.

3. The method according to claim 1, wherein the displaying of the online content comprises displaying one of an online article, an online pictorial, or an online video.

4. The method according to claim 1, wherein the displaying at least one option for purchasing an opportunity to advertise comprises displaying at least one of a fast-buy option, a bid option, and an auction option.

5. An apparatus, comprising:
at least one processor;
at least one memory comprising computer program code, said at least one memory being coupled to the at least one processor,
wherein the at least one memory and the computer program code are configured, with the at least one processor, to cause the apparatus to perform a method comprising
displaying an online content to a user;
displaying a graphical control associated with the online content, said graphical control being configured to receive a request to advertise in association with the online content, the graphical control being displayed when there is an opportunity to advertise in association with the online content, wherein the online content and the graphical control are displayed simultaneously;
determining that the user has accessed the graphical control;
determining that the user has accessed the graphical control;
displaying at least one option for purchasing an opportunity to advertise in association with the online content;
receiving payment from the user to purchase the opportunity to advertise in association with the online content; and
granting the opportunity to advertise in association with the online content.

6. The apparatus according to claim 5, wherein the graphical control comprises a clickable icon.

7. The apparatus according to claim 5, wherein the online content comprises an online article, an online pictorial, or an online video.

8. The apparatus according to claim 5, wherein the displaying at least one option for purchasing an opportunity to advertise comprises displaying at least one of a fast-buy option, a bid option, and an auction option.

9. A computer program product embodied on a non-transitory computer readable medium, the computer program product comprising computer code which, when run on a processor, controls the processor to perform a method comprising:
displaying an online content to a user;
displaying a graphical control associated with the online content, said graphical control being configured to receive a request to advertise in association with the online content, the graphical control being displayed when there is an opportunity to advertise in association with the online content, wherein the online content and the graphical control are displayed simultaneously;
determining that the user has accessed the graphical control;
determining that the user has accessed the graphical control;
displaying at least one option for purchasing an opportunity to advertise in association with the online content;
receiving payment from the user to purchase the opportunity to advertise in association with the online content; and
granting the opportunity to advertise in association with the online content.

10. The computer program product according to claim 9, wherein the step of displaying the graphical control comprises displaying a clickable icon.

11. The computer program product according to claim 9, wherein the step of displaying the online content comprises displaying an online article, an online pictorial, or an online video.

12. The computer program product according to claim 9, wherein the displaying at least one option for purchasing an opportunity to advertise comprises displaying at least one of a fast-buy option, a bid option, and an auction option.
